(19) United States
(12) Patent Application Publication
(10) Pub. No.: US 2025/0185716 A1
(43) Pub. Date: Jun. 12, 2025

(54) AEROSOL PROVISION DEVICE

(71) Applicant: Nicoventures Trading Limited, London (GB)

(72) Inventors: Ashley John SAYED, London (GB); Mitchel THORSEN, Madison, WI (US); Luke James WARREN, London (GB)

(73) Assignee: Nicoventures Trading Limited, London (GB)

(21) Appl. No.: 19/000,491

(22) Filed: Dec. 23, 2024

Related U.S. Application Data
(63) Continuation of application No. 17/593,151, filed on Sep. 10, 2021, now abandoned.
(60) Provisional application No. 62/816,273, filed on Mar. 11, 2019.

(51) Int. Cl. A24F 40/465; H05B 6/10

(52) U.S. Cl. CPC A24F 40/465; H05B 6/108

(57) ABSTRACT

An aerosol provision device comprises a tubular heater component configured to receive an article comprising aerosol generating material, wherein the heater component is heatable by penetration with a varying magnetic field. The device further comprises an inductor coil extending around the heater component, wherein the inductor coil is configured to generate the varying magnetic field. The heater component has an internal diameter of between about 5 mm and about 10 mm.

### PRIORITY CLAIM

The present application is a continuation application of U.S. patent application Ser. No. 17/593,151 filed Sep. 10, 2021, which is a National Phase entry of PCT Application No. PCT/EP2020/056227, filed Mar. 9, 2020, which claims priority from U.S. Provisional Application No. 62/816,273, filed Mar. 11, 2019, each of which is hereby fully incorporated herein by reference.

### TECHNICAL FIELD

The present invention relates to an aerosol provision device and an aerosol provision system.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided an aerosol provision device. The device includes a tubular heater component configured to receive an article comprising aerosol generating material; and a coil extending around the heater component, wherein the coil is configured to heat the heater component; wherein the heater component has an internal diameter of between about 5 mm and about 10 mm.

According to a second aspect of the present disclosure there is provided an aerosol provision system. The system includes an article comprising aerosol generating material; and an aerosol provision device according to the first aspect.

According to a third aspect of the present disclosure there is provided an aerosol provision system. The system includes an article comprising aerosol generating material; and an aerosol provision device, comprising: a tubular heater component configured to receive the article, wherein the heater component has an internal diameter of between about 5 mm and about 10 mm; and a coil extending around the heater component, wherein the coil is configured to heat the heater component.

According to a fourth aspect of the present disclosure there is provided an aerosol provision system. The system includes an article comprising aerosol generating material; a tubular heater component configured to receive the article; and a coil extending around the heater component, wherein the coil is configured to heat the heater component; wherein the article has an outer layer having a thickness of between about 0.02 mm and about 0.06 mm, such that an outer surface of the aerosol generating material is positioned away from the heater component by at least the thickness of the outer layer.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a front view of an example of an aerosol provision device;

FIG. 2 shows a front view of the aerosol provision device of FIG. 1 with an outer cover removed;

FIG. 3 shows a cross-sectional view of the aerosol provision device of FIG. 1;

FIG. 4 shows an exploded view of the aerosol provision device of FIG. 2;

FIG. 5A shows a cross-sectional view of a heating assembly within an aerosol provision device;

FIG. 5B shows a close-up view of a portion of the heating assembly of FIG. 5A;

FIG. 6 shows a front view of an example susceptor for use within an aerosol provision device;

FIG. 7 shows a diagrammatic representation of a cross section through an example susceptor and article; and

FIG. 8 shows a diagrammatic representation of a cross section through an example susceptor.

### DETAILED DESCRIPTION OF THE DRAWINGS

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatuses are known that heat aerosol generating material to volatilize at least one component of the aerosol generating material, typically to form an aerosol which can be inhaled, without burning or combusting the aerosol generating material. Such apparatuses are sometimes described as an “aerosol generating device,” an “aerosol provision device,” a “heat-not-burn device,” a “tobacco heating product device,” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

A first aspect of the present disclosure defines a tubular heater component which receives an article comprising aerosol generating material. For example, the heater component may be hollow and can receive the article therein. The heater component therefore surrounds the article and the aerosol generating material. In some examples, the heater component is a susceptor. As will be discussed in more detail herein, a susceptor is an electrically conducting object, which is heated via electromagnetic induction. The susceptor is heated by penetrating the susceptor with a varying magnetic field, produced by at least one coil, such as an inductor coil. Once heated, the susceptor transfers heat to the aerosol generating material, which releases the aerosol.

In one example, the article is tubular or cylindrical in nature, and may be known as a “tobacco stick”, for example, the aerosolizable material may comprise tobacco formed in a specific shape which is then coated, or wrapped in one or more layers of material, such as paper or foil.

In the first aspect of the present disclosure, the heater component has an internal diameter of between about 5 mm and about 10 mm. It has been found that an internal diameter within this range can efficiently heat aerosol generating material received within the heater component. The aerosol generating material arranged closest to the heater component will be heated first, whereas aerosol generating material located in the center of the heater component will be heated later as heat travels through the aerosol generating material. A heater component with dimensions of this size allows the center of the aerosol generating material to be heated to a sufficient temperature without overheating the aerosol generating material located closest to the heater component.

Preferably, the heater component has an internal diameter of between about 5 mm and about 8 mm. In one example, the internal diameter is between about 5 mm and about 6 mm. For example, the internal diameter is between about 5.3 mm and about 5.8 mm, between about 5.4 mm and about 5.7 mm, or between about 5.5 mm and about 5.6 mm, such as about 5.55 mm.

In another example, the internal diameter is between about 6 mm and about 7.5 mm. For example, the internal diameter is between about 6.5 mm and about 7.5 mm, between about 6.6 mm and about 6.9 mm, or between about 6.8 mm and about 6.9 mm, such as about 6.85 mm. In another example, the internal diameter is between about 6.8 mm and about 7.3 mm, or between about 7 mm and about 7.2 mm, such as about 7.1 mm.

In some examples, in use, the one or more coils are configured to heat the heater component to a temperature of between about 240° C. and about 300° C., or between about 250° C. and about 280° C.

The heater component may have a wall thickness of between about 0.025 mm and about 0.075 mm. The thickness of the heater component is the average distance between an inner surface and an outer surface of the heater component. The thickness may be measured in a direction perpendicular to the longitudinal axis of the heater component. The wall thickness may be between about 0.04 mm and about 0.06 mm. It is desirable to make the heater component thin to ensure that it is heated quickly and most efficiently (by having less material to heat up). However, if the heater component is too thin, the heater component is fragile and difficult to manufacture. It has been found that a heater component with a wall thickness of between about 0.025 mm and about 0.075 mm provides a good balance between these considerations. Preferably the heater component has a wall thickness of about 0.05 mm, which can provide a robust heater component that is quick to heat. A heater component with a wall thickness of this dimension and the above-mentioned diameter is particularly effective at heating aerosol generating material that is located within the tubular heater component.

In certain examples, the device is dimensioned so as to receive an article having an outer diameter that is substantially the same as the internal diameter of the heater component. In such a case, the outer surface of the article is in contact with the inner surface of the heater component when located within the heater component. This ensures that the heating is most efficient because there is no insulating air gap between the heater component and article. The article can also be heated by contact with the heater component.

In a particular example, the article has an outer diameter of between about 5.3 mm and about 5.5 mm, such as about 5.4 mm. Such an article would be suitable for use in a heater component having an internal diameter of between about 5 mm and about 6 mm.

In another example, the article has an outer diameter of between about 6.6 mm and about 6.8 mm, such as about 6.7 mm. Such an article would be suitable for use in a heater component having an internal diameter of between about 6 mm and about 7.5 mm.

In some examples the article comprises aerosol generating material surrounded by an outer layer. The outer layer may be paper or foil, for example. The outer layer may have a certain thickness. For example, the thickness may be between about 0.02 mm and about 0.06 mm.

In a certain example, the article may have an outer layer having a thickness of between about 0.02 mm and about 0.06 mm, such that an outer surface of the aerosol generating material is positioned away from the heater component by at least the thickness of the outer layer when the article is received within the heater component. Thus, in examples where the article has an outer diameter that is substantially the same as the inner diameter of the heater component, the outer layer may abut the inner surface of the heater component. In that case, only the outer layer separates the aerosol generating material from the heater component. In other examples however, the article may have an outer diameter that is smaller than the inner diameter of the heater component such that an air gap and the outer layer separates the aerosol generating material from the heater component. While this arrangement may be less efficient at heating the aerosol generating material, it can make it easier for a user to insert the article into the heater component. The air gap may also partially insulate the outer layer, so that it does not become charred which could impact the flavor of the aerosol. In addition, an air gap can also reduce the likelihood of the article sticking to the inner surface of the heater component. Aerosol and water vapor may cause the article to stick to the heater component and this risk can be reduced by an air gap. The air gap extends around the article.

In some examples the air gap has a width of between about 0 mm and about 1 mm or between about 0 mm and about 0.3 mm. For example, the air gap may be between about 0.05 mm and about 0.3 mm, between about 0.05 mm and about 0.3 mm, between about 0.05 mm and about 0.2 mm, between about 0.05 mm and about 0.15 mm, or between about 0.05 mm and about 0.13 mm. An air gap with these dimensions provides a good balance between providing easier insertion and avoiding sticking (by making the air gap larger) and improving heating efficiency (by making the air gap smaller).

Accordingly, an outer surface of the aerosol generating material may be positioned away from an inner surface of the heater component by a distance of between about 0.02 mm and about 1 mm when the article is received within the heater component. The outer surface of the aerosol generating material is the surface which is in contact with the outer layer of the article. Preferably the outer surface of the aerosol generating material is positioned away from an inner surface of the heater component by a distance of between about 0.02 mm and about 0.3 mm when the article is received within the heater component. This ensures that the aerosol generating material is located close enough to be adequately heated, and reduce the air gap spacing, which can stop the aerosol generating material from being heated. In some examples, the outer surface of the aerosol generating material is positioned away from the inner surface of the heater component by a distance of between about 0.1 mm and about 0.2 mm, or between about 0.12 mm and about 0.15 mm, or between about 0.12 mm and about 0.14 mm. This spacing ensures the aerosol generating material is close enough to be adequately heated, and also far enough away to avoid charring. Furthermore, this spacing allows the article to be more easily inserted.

In some examples, the heater component defines a longitudinal axis and the heater component has a first length measured along the longitudinal axis. The aerosol generating material received within the heater component has a second length measured along the longitudinal axis. In some arrangements, the ratio of the first length to the second length is between about 1.03 and 1.1. It has been found that in such cases the aerosol generating material can be heated most effectively, and the temperature of the aerosol generated can be better controlled. Because the heater component is longer than the aerosol generating material, the aerosol continues to be heated by the heater component as it flows towards the user's mouth. Furthermore, because of the additional length of the heater component, the aerosol generating material nearest the end of the heater component is evenly heated. If the aerosol generating material is not fully heated it can act as a filter, which reduces the volume and temperature of aerosol reaching the user's mouth. If the heater component extends beyond the aerosol generating material by too much, the aerosol can overheat. For example, in a specific arrangement, the article comprising the aerosol generating material can comprise a cooling component, such as a heat displacement collar, arranged adjacent to the aerosol generating material. If the heater component is too long it can heat the cooling component thereby reducing its effectiveness at controlling the temperature of the aerosol.

Accordingly, when the ratio of the first length to the second length is between about 1.03 and 1.1, the aerosol can be heated most effectively. For example, the ratio of the first length to the second length may be between about 1.04 and 1.07, or between about 1.05 and 1.06. These ranges provide a good balance between the above-mentioned considerations.

In the above example, the device/heater component is configured such that the distal end of the article/aerosol generating material is flush with the distal end of the heater component when the aerosol generating material is received within the heater component. The proximal end of the heater component therefore extends beyond the proximal end of the aerosol generating material. The proximal end is the end which is closest to the user's mouth when the device is in use. Aerosol therefore flows towards the proximal end when the user draws on the device.

In one example, an end of the heater component extends beyond an end of the aerosol generating material by less than about 5 mm, by less than about 4 mm, by less than about 3 mm, or by less than about 2.5 mm. The end of the heater component may also extend beyond the end of the heater component by more than about 1.5 mm or by more than about 2 mm. For example, the end of the heater component may extend beyond the end of the aerosol generating material by about 2.5 mm.

In a particular example, the first length is between about 40 mm and about 50 mm, between about 40 mm and about 45 mm, or between about 44 mm and about 45 mm, such as about 44.5 mm.

In a further example, the second length is between about 35 mm and about 49 mm or between about 36 mm and about 44 mm. In another example, the second length is between about 40 mm and about 44 mm, such as about 42 mm.

In a preferred example, the first length is about 44.5 mm and the second length is about 42 mm. The ratio between the first length and the second length is therefore about 1.06, and the proximal end of the heater component extends beyond the proximal end of the aerosol generating material by about 2.5 mm.

The heater component may have a circular cross section. The heater component may have an external diameter of between about 5 mm and about 8 mm. For example, the heater component may have an external diameter of between about 5 mm and about 6 mm, such as about 5.6 mm.

In a specific arrangement the proximal end of the heater component is flared. That is, an end portion of the heater component has a larger internal and external diameter than a main portion of the heater component. In the flared region, the heater component is further away from the outer surface of the article than in the main portion. The flared end allows the article to be inserted into the heater component more easily. In one example the flared portion has a length along the longitudinal axis of less than about 1 mm, and is preferably about 0.5 mm in length. The flared end may also have a circular cross section with an external diameter of between about 5 mm and about 7 mm. For example, the flared end of the heater component have an external diameter of between about 6 mm and about 7 mm, such as about 6.5 mm.

In one arrangement, the article has a total length of between about 70 and 90 mm, such as about 83 mm or about 75 mm. The article may comprise a heat displacement collar arranged adjacent to the aerosol generating material.

In some examples the heater component comprises carbon steel. Carbon steel is a ferromagnetic material which generates heat through Joule heating as a result of an induced magnetic field, as well as additional heat through magnetic hysteresis. Carbon steel has been found to provide effective heating of aerosol generating material.

In one example, the heater component comprises mild steel.

The heater component may also be at least partially plated by one or more other materials. That is, the electrically conductive material of carbon steel may also be coated in one or more other materials. The plating/coating may be applied in any suitable manner, such as via electroplating, physical vapor deposition, etc.

In one example, the heater component is at least partially plated in nickel. Nickel has good anti-corrosion properties, and therefore stops the heater component from corroding. Alternatively, the heater component may be at least partially plated cobalt. Cobalt also has good anti-corrosion properties. Furthermore, nickel and cobalt are also ferromagnetic, and thus generate additional heat through magnetic hysteresis.

The heater component may have an emissivity of less than about 0.1. In one example, the low emissivity may be achieved through plating/coating the heater component in nickel or cobalt, for example. When the heater component has a low emissivity, the rate at which energy is lost through radiation is reduced. If the energy radiated ends up being lost to the environment, then such radiation can reduce the system energy efficiency. A heater component with an emissivity of less than about 0.1 is therefore more efficient at heating aerosol generating material.

The emissivity of an object can be measured using well-known techniques.

Preferably the heater component has an emissivity of between about 0.06 and about 0.09.

In a specific example, the heater component may comprise carbon steel which is at least partially plated in nickel. Such a heater component can have an emissivity of between about 0.06 and about 0.09.

Preferably, the plating of nickel or cobalt covers the whole of the heater component, such as on an inner and outer surface of the heater component. By coating the outside of the heater component, the emissivity of the heater component can be lowered, thereby reducing the amount of heat loss through radiation.

Alternatively, the plating may cover only an inner surface of the heater component, thereby reducing the amount of nickel/cobalt required.

In one example, the heater component comprises an alloy comprising at least 99 wt % Iron. A material with a high iron content exhibits strong ferromagnetic properties, and generates heat through Joule heating as a result of an induced magnetic field, as well as additional heat through magnetic hysteresis. A heater component with high iron content therefore provides a more effective method of heating a heater component. Preferably the alloy comprises at least 99.1 wt % iron. More specifically, the alloy may comprise between about 99.0 wt % and about 99.7 wt % Iron, such as between about 99.15 wt % and about 99.65 wt % iron. The alloy may, in some examples, be carbon steel.

Preferably the alloy comprises between about 99.18 wt % and about 99.62 wt % Iron. Thus, in some examples the heater component comprises AISI 1010 Carbon Steel. AISI 1010 Carbon Steel is a particular specification of carbon steel as defined by the American Iron and Steel Institute.

As mentioned, the heater component may also be at least partially plated in nickel or cobalt.

In one example, the heater component has a mass of between about 0.25 g and about 1 g. For example, the heater component may have a mass of greater than about 0.25 g. Alternatively, the heater component may have a mass of less than about 1 g.

It has been found that a heater component with a mass within this range is particularly efficient at heating aerosol generating material. For example, a low mass heater component allows the heater component to be heated quicker and also decreases the amount of energy stored within the heater component which results in a greater heat transfer efficiency to the aerosol generating material. A heater component with a mass of less than about 1 g is therefore well suited for heating aerosol generating material. In addition, low mass is preferable to reduce the overall mass of the device, and to reduce costs. In contrast, a heater component that is too lightweight can be easily damaged, and is difficult to manufacture. A mass within the above range provides a good balance between these considerations.

Preferably the heater component has a mass of between about 0.25 g and about 0.75 g, or a mass of between about 0.4 g and about 0.6 g. Still more preferably, the heater component has a mass of about 0.5 g.

In one example, the heater component has a first mass and the aerosol generating material has a second mass, wherein the ratio of the first mass to the second mass is between about 1.5 and about 2.5. For example, the ratio may be between about 1.8 and about 2.2, or between about 1.9 and about 2. It has been found that when the ratio is within this range, the heater component can efficiently heat the aerosol generating material within a short period of time. For example, the aerosol generating material can be heated to about 250° C. in around 20 seconds.

The second mass may be between about 0.25 g and about 0.35 g. Preferably the mass is between about 0.25 g and about 0.27 g, such as about 0.26 g.

In a particular example, the first mass is between about 0.4 g and about 0.6 g, such as about 0.5 g and the second mass is between about 0.25 g and about 0.27 g, such as about 0.26 g. In the example where the first mass is 0.5 g and the second mass is 0.26 g, the ratio of the first mass to the second mass is about 1.9.

The heater component may have a density of between 7 and 9 g cm⁻³. Preferably the density is between about 7 and 8 g cm⁻³, such as between about 7.8 and 7.9 g cm⁻³.

The heater component may have a unitary construction. A unitary construction can mean that the heater component is easier to manufacture, and is less likely to fracture.

The heater component can be initially formed by rolling a sheet of material (such as metal) into a tube and sealing/welding the heater component along the seam. In some examples, the ends of the sheet overlap when they are sealed. In other examples, the ends of the sheet do not overlap when they are sealed. In another example, the heater component is initially formed by deep drawing techniques. This technique can provide a heater component that is seamless. The first example mentioned above can, however, produce a heater component in a shorter period of time.

Other methods of forming a seamless heater component include reducing the wall thickness of a relatively thick hollow tube to provide a relatively thin hollow tube. The wall thickness can be reduced by deforming the relatively thick hollow tube. In one example, the wall can be deformed using swaging techniques. In one example, the wall can be deformed via hydroforming, where the inner circumference of the hollow tube is increased. High pressure fluid can exert a pressure on the inner surface of the tube. In another example, the wall can be deformed via ironing. For example, the walls of the heater component tube can be pressed together between two surfaces.

Preferably, the device is a tobacco heating device, also known as a heat-not-burn device.

As briefly mentioned above, in some examples, the coil(s) is/are configured to, in use, cause heating of at least one electrically-conductive heating component/element (also known as a heater component/element), so that heat energy is conductible from the at least one electrically-conductive heating component to aerosol generating material to thereby cause heating of the aerosol generating material.

In some examples, the coil(s) is/are configured to generate, in use, a varying magnetic field for penetrating at least one heating component/element, to thereby cause induction heating and/or magnetic hysteresis heating of the at least one heating component. In such an arrangement, the or each heating component may be termed a “susceptor”. A coil that is configured to generate, in use, a varying magnetic field for penetrating at least one electrically-conductive heating component, to thereby cause induction heating of the at least one electrically-conductive heating component, may be termed an “induction coil” or “inductor coil”.

The device may include the heating component(s), for example electrically-conductive heating component(s), and the heating component(s) may be suitably located or locatable relative to the coil(s) to enable such heating of the heating component(s). The heating component(s) may be in a fixed position relative to the coil(s). Alternatively, both the device and such an article may comprise at least one respective heating component, for example at least one electrically-conductive heating component, and the coil(s) may be to cause heating of the heating component(s) of each of the device and the article when the article is in the heating zone.

In some examples, the coil(s) is/are helical. In some examples, the coil(s) encircles at least a part of a heating zone of the device that is configured to receive aerosol generating material. In some examples, the coil(s) is/are helical coil(s) that encircles at least a part of the heating zone. The heating zone may be a receptacle, shaped to receive the aerosol generating material.

In some examples, the device comprises an electrically-conductive heating component that at least partially surrounds the heating zone, and the coil(s) is/are helical coil(s) that encircles at least a part of the electrically-conductive heating component. In some examples, the electrically-conductive heating component is tubular. In some examples, the coil is an inductor coil.

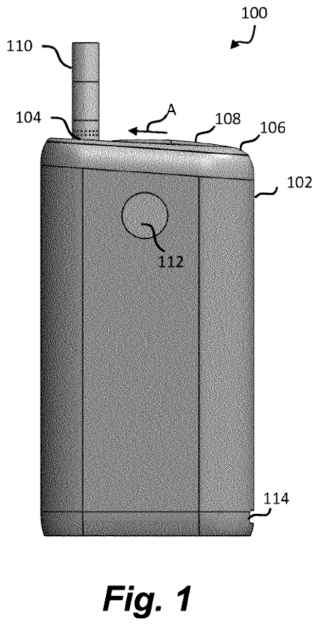

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 1, the lid 108 is shown in an open configuration, however the lid 108 may move into a closed configuration. For example, a user may cause the lid 108 to slide in the direction of arrow “A”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

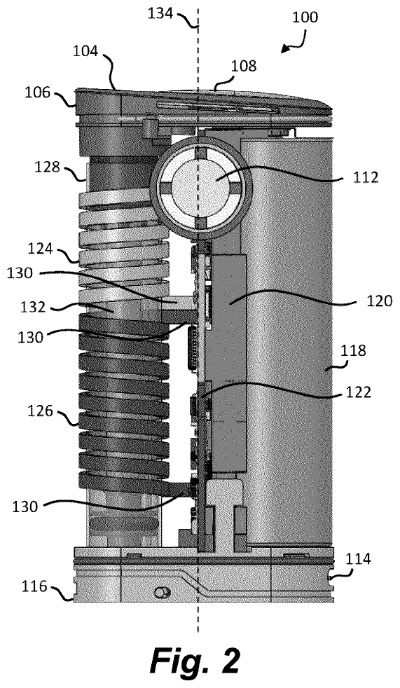

FIG. 2 depicts the device 100 of FIG. 1 with the outer cover 102 removed and without an article 110 present. The device 100 defines a longitudinal axis 134.

As shown in FIG. 2, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100.

The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery, (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular.

The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 2, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This is can be useful when the inductor coils are active at different times. For example, initially, the first inductor coil 124 may be operating to heat a first section of the article 110, and at a later time, the second inductor coil 126 may be operating to heat a second section of the article 110. Winding the coils in opposite directions helps reduce the current induced in the inactive coil when used in conjunction with a particular type of control circuit. In FIG. 2, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 120 is tubular, with a circular cross section.

The device 100 of FIG. 2 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 2, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

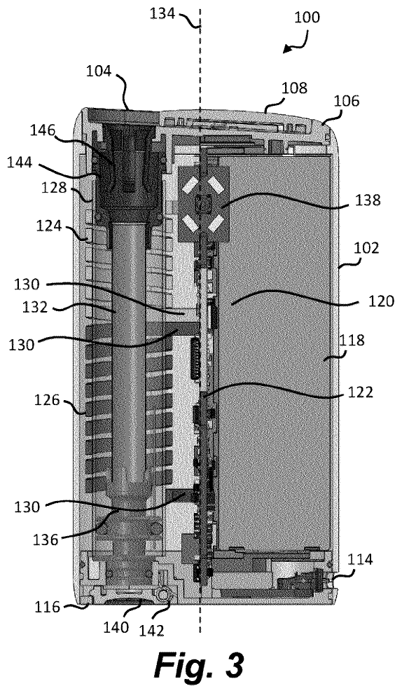

FIG. 3 shows a side view of device 100 in partial cross-section. The outer cover 102 is present in this example. The rectangular cross-sectional shape of the first and second inductor coils 124, 126 is more clearly visible.

The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

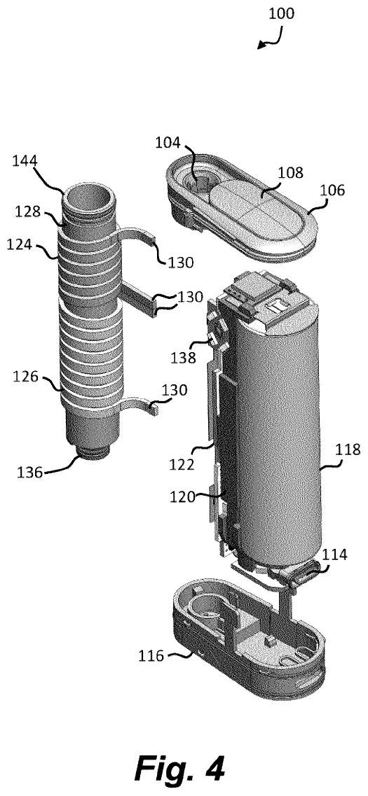

FIG. 4 is an exploded view of the device 100 of FIG. 1, with the outer cover 102 omitted.

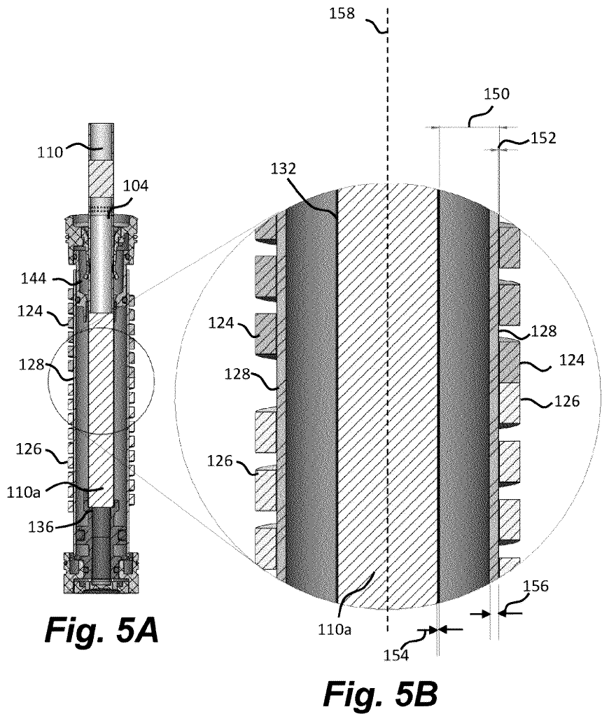

FIG. 5A depicts a cross section of a portion of the device 100 of FIG. 1. FIG. 5B depicts a close-up of a region of FIG. 5A. FIGS. 5A and 5B show the article 110 received within the susceptor 132. In this example, the example article 110 is dimensioned so that the outer surface of the article 110 abuts the inner surface of the susceptor 132. This ensures that the heating is most efficient. In other examples there may be an air gap between the outer surface of the article and the inner surface of the susceptor 132. The article 110 of this example comprises aerosol generating material 110a. The aerosol generating material 110a is positioned within the susceptor 132. The article 110 may also comprise other components such as a filter and/or a cooling structure. In some examples the article 110 has an outer layer of material such as paper and/or foil.

FIG. 5B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3 mm to 3.5 mm, or about 3.25 mm.

FIG. 5B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of between about 0.025 mm and about 0.075 mm, such as about 0.05 mm.

In one example, the susceptor 132 has a length of between about 40 mm and about 60 mm, or between about 40 mm and about 45 mm, such as about 44.5 mm.

In one example, the insulating member 128 has a wall thickness 156 of between about 0.25 mm and about 2 mm, or between about 0.25 mm and about 1 mm, such as about 0.5 mm.

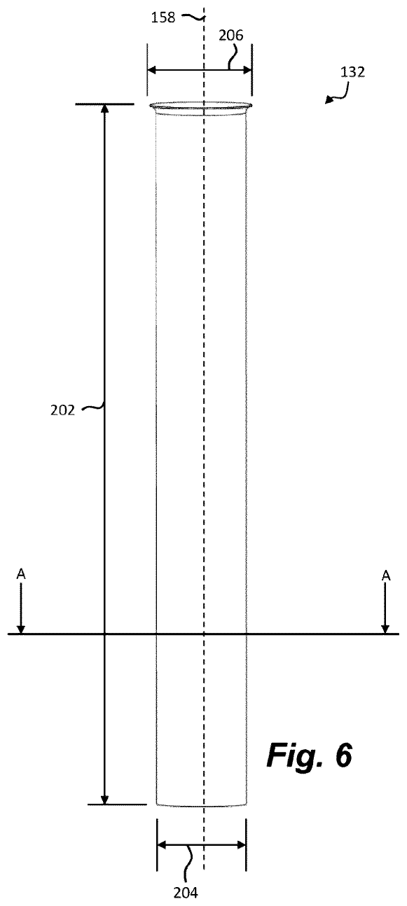

FIG. 6 depicts the susceptor 132 which, in this example, is constructed from a single piece of material and therefore has unitary construction. As mentioned above, the susceptor 132 is hollow and tubular can receive an article comprising aerosol generating material. In this example, the susceptor 132 is substantially cylindrical with a substantially circular cross section, but in other examples the susceptor 132 may have an oval, elliptical, polygonal, quadrilateral, rectangular, square, triangular, star-shaped, or irregular cross section, for example.

To make it easier for the aerosol generating material to be received within the susceptor, the susceptor 132 may have a flared end. The flared end is formed towards the end of the susceptor 132 which receives the aerosol generating material. In this example, the flared end is arranged at a proximal/mouth end of the susceptor 132. In another example, the flared end can be omitted, such that the susceptor 132 has substantially the same size cross section along its length.

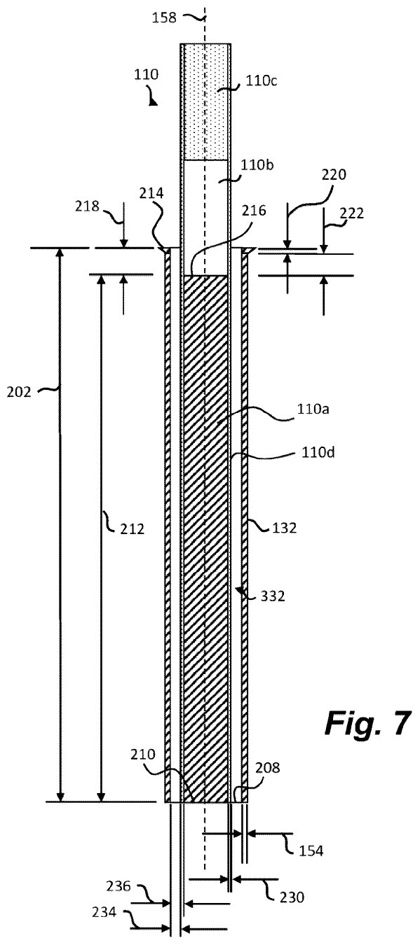

FIG. 7 depicts a diagrammatic representation of a cross section through the susceptor 132 and through an example article 110. The article 110 is received within the susceptor 132.

As shown, the susceptor 132 has a length 202 measured in a direction perpendicular to the longitudinal axis 158 of the susceptor. As shown in FIG. 6, the susceptor 132 has an external diameter 204, where the external diameter is measured in a direction perpendicular to the axis 158, between outer edges of the susceptor 132. The external diameter 204 may be between about 5 mm and about 7 mm. The internal diameter of the susceptor 132 may be between about 5 mm and about 7 mm. The internal diameter is measured in a direction perpendicular to the axis 158, between inner surfaces of the susceptor 132.

In the examples of FIGS. 5-8, the internal diameter of the susceptor 132 is between about 5.4 mm and about 5.6 mm, such as about 5.5 mm. The outer diameter 204 is between about 5.5 mm and about 5.7 mm, such as about 5.6 mm. The wall thickness 154 may be about 0.05 mm, for example.

The flared portion of the susceptor may have an external diameter 206 of between about 6 mm and about 7 mm, such as about 6.5 mm.

As briefly mentioned, the article 110 comprises aerosol generating material 110a, which is fully surrounded by the susceptor 132.

In some examples, the article 110 further comprises a cooling segment/component 110b, such as a heat displacement collar. In one example, the cooling segment 110b is located adjacent the body of aerosol-generating material 110a between the body of aerosol-generating material 110a and a filter segment 110c, such that the cooling segment 110b is in an abutting relationship with the aerosol-generating material 110a and the filter segment 110c. In other examples, there may be a separation between the body of aerosol-generating material 110a and the cooling segment 110b and between the cooling segment 110b and the filter segment 110c.

The cooling segment 110b acts to cool the aerosol as it flows through the cooling segment 110b. In a specific example, the cooling segment 110b is made from paper and cools the aerosol by about 40° C. In one example the length of the cooling segment 110b is at least 15 mm. For example, the length of the cooling segment 110b may be between 20 mm and 30 mm, such as about 25 mm.

The article 110 may also comprise a filter segment 110c. The filter segment 110c may be formed of any filter material sufficient to remove one or more volatilized compounds from heated volatilized components from the aerosol generating material. here may also be greater or fewer components present in the article 110.

In the example shown, the article 110 is surrounded by an outer layer 110d. The outer layer 110b may be paper or foil for example. The outer layer 110d may cover the full length of the article 110, or may only cover a portion of the length of the article 110. Preferably the aerosol generating material 110a is surrounded by the outer layer 110d.

The outer layer 110d may have a thickness 230 of between about 0.02 mm and about 0.06 mm. In other examples, the thickness 230 may be between about 0.01 mm and about 0.1 mm.

In the example of FIG. 7, there is an air gap 332 surrounding the article 110. The outer surface of the article is therefore spaced apart from the inner surface of the susceptor 132 by a distance 234 when the article is located in the center of the susceptor 132.

Accordingly, in the example of FIG. 7, an outer surface of the aerosol generating material is positioned away from the inner surface of the susceptor by the thickness 230 of the outer layer 110d and the width 234 of the air gap 332. Preferably, the outer surface of the aerosol generating material 110a is positioned away from the inner surface of the susceptor 132 by a distance 236 of between about 0.02 mm and about 0.25 mm. The width 234 of the air gap 332 may therefore be between about 0 mm and about 0.18 mm for example. In the example shown, the outer surface of the aerosol generating material 110a is positioned away from the inner surface of the susceptor 132 by a distance 236 of about 0.15 mm.

In some examples, there is no air gap such that the outer surface of the article 110 abuts the inner surface of the susceptor 132. The outer surface of the aerosol generating material 110a is therefore positioned away from the inner surface of the susceptor 132 by the thickness 230 of the outer layer 110d. In such a case, the outer diameter of the article 110 would be substantially the same as the internal diameter of the susceptor 132.

As shown in FIG. 7, the article 110 is received within the susceptor 132, and preferably a distal end 208 of the susceptor 132 is flush with a distal end 210 of the aerosol generating material 110a. The aerosol generating material 110a has a length 212, which may be shorter than the length 202 of the susceptor 132. A proximal end 214 of the susceptor 132 preferably extends beyond a proximal end 216 of the aerosol generating material 110a by a distance 218. The distance 218 may be between about 1 mm and about 5 mm for example.

The length 202 of the susceptor 132 may be between about 40 mm and about 50 mm, and the length 212 of the aerosol generating material 110a may be between about 35 mm and about 49 mm. The ratio of the length 202 to the length 212 is preferably between about 1.03 and about 1.1.

In the present example, the length 202 of the susceptor 132 is about 44.5 mm, and the length 212 of the aerosol generating material 110a is about 42 mm, such that the ratio of the length 202 to the length 212 is about 1.06. The proximal end 214 of the susceptor 132 there extends beyond the proximal end 216 of the aerosol generating material 110a by a distance 218 of about 2.5 mm.

In the present example, the flared end of the susceptor 132 extends along the susceptor 132 by a distance 220 of about 0.5 mm such that the proximal end 216 of the aerosol generating material 110a lies a distance 222 of about 2 mm away from the flared portion.

In some examples, the susceptor has a mass of between about 0.25 g and about 1 g. The aerosol generating material 110a may also have a mass of between about 0.25 g and about 0.35 g. In the present example, the susceptor has a mass of about 0.5 g and the aerosol generating material 110a has a mass of about 0.26 g.

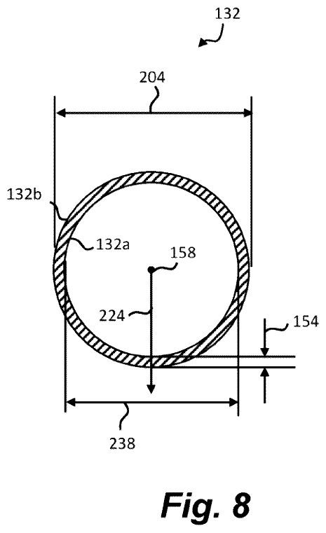

FIG. 8 depicts a cross-section of the susceptor 132 through line A-A shown in FIG. 6. As shown in this example, the susceptor 132 is cylindrical such that the cross section of the susceptor 132 is circular in shape. The susceptor 132 has an inner surface 132a and an outer surface 132b. The inner surface 132a is radially closer to the longitudinal axis 158 than the outer surface 132b. As previously mentioned, the susceptor 132 has a thickness 154, which is the average distance between the inner surface 132a and the outer surface 132b, measured in a direction 224 that is perpendicular to the longitudinal axis 158. The thickness 154 may be between about 0.025 mm and 0.075 mm.

In this example, the thickness is about 0.05 mm, the outer diameter 204 of the susceptor is about 5.6 mm and the inner diameter 238 is about 5.5 mm. A ratio of the outer diameter 204 to the wall thickness 154 may therefore be between about 110 and 115, such as about 112.

The susceptor 132 is made from an electrically conductive material, such as carbon steel, which may be at least partially plated with nickel or cobalt. Preferably the susceptor is plated on at least the inner surface 132a of the susceptor 132. The thickness 154 of the susceptor 132 includes the thickness of the plating.

In some examples, the plating of nickel or cobalt has a thickness of about 10 microns (0.01 mm). However, in other embodiments, the plating may have a different thickness, such as a thickness of no more than 50 microns or no more than 20 microns. For example, the plating may have a thickness of about 15 microns.

In certain examples, the susceptor 132 comprises an alloy comprising at least 99 wt % iron. For example, the electrically conductive material comprises at least 99Wt % iron, and is at least partially plated with nickel or cobalt. Preferably the susceptor 132 comprises carbon steel with between about 99.18 wt % and 99.62 wt % Iron with a coating of nickel or cobalt. Carbon steel with an iron content of between about 99.18 wt % and 99.62 wt % Iron may be known as AISI 1010 carbon steel.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision system, comprising:
an article comprising aerosol generating material; and
an aerosol provision device, comprising:
a tubular heater component configured to receive the article, wherein the tubular heater component has an internal diameter of between about 5 mm and about 10 mm; and
a coil extending around the tubular heater component, wherein the inductor coil is configured to heat the tubular heater component;
wherein the article has an outer layer having a thickness of between about 0.02 mm and about 0.06 mm, such that an outer surface of the aerosol generating material is positioned away from the tubular heater component by at least the thickness of the outer layer when the article is received within the tubular heater component.

2. The aerosol provision device of claim 1, wherein the tubular heater component has a wall thickness between about 0.04 mm and about 0.06 mm.

3. The aerosol provision system according to claim 1, wherein the tubular heater component has an internal diameter of between about 5.4 mm and about 5.6 mm.

4. The aerosol provision system according to claim 1, wherein the tubular heater component has a wall thickness of between about 0.025 mm and about 0.075 mm.

5. The aerosol provision system according to claim 1, wherein the outer surface of the aerosol generating material is positioned away from an inner surface of the tubular heater component by a distance of between about 0.02 mm and about 1 mm when the article is received within the tubular heater component.

6. The aerosol provision system according to claim 1, wherein the article has an outer diameter that is substantially the same as the internal diameter of the tubular heater component.

7. An aerosol provision system, comprising:
an article comprising aerosol generating material;
a tubular heater component configured to receive the article; and
a coil extending around the heater component, wherein the coil is configured to heat the heater component;
wherein the article has an outer layer having a thickness of between about 0.02 mm and about 0.06 mm, such that an outer surface of the aerosol generating material is positioned away from the heater component by at least the thickness of the outer layer.

8. The aerosol provision system according to claim 7, wherein the outer surface of the aerosol generating material is positioned away from an inner surface of the tubular heater component by a distance of between about 0.02 mm and about 0.3 mm.

9. The aerosol provision system according to claim 7, wherein the article has an outer diameter of between about 5 mm and about 8 mm.
